(19) United States
(12) Patent Application Publication
(10) Pub. No.: US 2022/0245775 A1
(43) Pub. Date: Aug. 4, 2022

(54) TONE MAPPING METHOD AND ELECTRONIC DEVICE

(71) Applicant: PEKING UNIVERSITY SHENZHEN GRADUATE SCHOOL, Shenzhen (CN)

(72) Inventors: Ronggang WANG, Shenzhen (CN); Ning ZHANG, Shenzhen (CN); Wen GAO, Shenzhen (CN)

(21) Appl. No.: 17/725,334

(22) Filed: Apr. 20, 2022

Related U.S. Application Data
(63) Continuation-in-part of application No. PCT/CN2019/118585, filed on Nov. 14, 2019.

(30) Foreign Application Priority Data
Oct. 31, 2019 (CN) 201911057461.1

(51) Int. Cl. G06T 5/00; G06T 5/50; G06N 3/04

(52) U.S. Cl. CPC G06T 5/009; G06T 5/50; G06T 2207/20084; G06T 2207/20208; G06T 2207/20221; G06N 3/0454

(57) ABSTRACT

A tone mapping method is provided. This method includes: obtaining one or a plurality of high dynamic range images, and determining a storage format of each high dynamic range image; performing an image decomposition on the high dynamic range image to obtain a first component, a second component and a third component, when the storage format of the high dynamic range image is determined as a predetermined storage format; inputting the first component and the second component into a predetermined deep neural network, and using the deep neural network to perform mapping on the first component and the second component respectively to obtain a first mapped component and a second mapped component; and fusing the first mapped component and the second mapped component with the third component to obtain a fused low dynamic range image corresponding to the high dynamic range image.

### CROSS-REFERENCE TO RELATED APPLICATIONS

This application is a continuation-in-part of PCT International patent application No. PCT/CN2019/118585, filed on Nov. 14, 2019, which claims priority to Chinese Patent Application No. 201911057461.1 filed on Oct. 31, 2019, the entire contents of which are incorporated herein by reference for all purposes.

### FIELD

The present disclosure relates to the technical field of digital image processing, and particularly relates to atone mapping method, atone mapping device, and an electronic device.

### BACKGROUND

With the rapid development of high dynamic range (High Dynamic Range, HDR) technology, various videos, images and other contents with high dynamic ranges are increasing, a high dynamic range image can provide more dynamic range and image details as compared to a common dynamic range image, thus, the high dynamic range image can restore a better visual effect in a real environment. However, since most multimedia devices still show images with limited dynamic range (i.e., low dynamic range), the high dynamic range image cannot be normally displayed on such multimedia devices, how to properly display the high dynamic range image on such devices, that is, tone mapping technology, has become an important technique in the technical field of digital image processing. Since the tone mapping is limited to conditions such as bit depths of the multimedia devices, the high dynamic range image cannot be completely and consistently reproduced on the multimedia devices, how to preserve as many local image details as possible while compressing dynamic range of an image, that is, how to restore an image with high dynamic range as much as possible, has become an emphasis of research.

In the related art, a high dynamic range image is divided into a basic layer and a detail layer through a filter, the base layer includes low-frequency information such as image value, the detail layer includes high-frequency information such as image edge, the basic layer is compressed, and the detail layer is enhanced; finally, the basic layer and the detail layer are fused into a low-dynamic range image. However, a filtering process may introduce noise such as halo, artifact, etc., and these noises may seriously affect the result of tone mapping, so that chromatic aberration is prone to be caused, naturalness of the image is reduced, the existing tone mapping method cannot complete conversion from the high dynamic range image to the low dynamic range image robustly.

Based on the prior art, there is a need to provide atone mapping method that can be avoided from noise interference, can reduce chromatic aberration of image, and can robustly complete image conversion from high dynamic range image to low dynamic range image.

### SUMMARY

In view of this, an objective of the present disclosure is providing atone mapping method, a tone mapping device and an electronic device, which aims to solve a problem that the tone mapping that exists in the related art may cause chromatic aberration, and image conversion is not robust enough.

In order to solve the technical problem discussed above, the embodiments of the present disclosure are implemented in this way:

A tone mapping method is provided in one embodiment of the present disclosure, this method includes:

obtaining one or a plurality of high dynamic range images, and determining a storage format of each high dynamic range image;

performing an image decomposition on the high dynamic range image to obtain a first component, a second component and a third component of the high dynamic range image, when the storage format of the high dynamic range image is determined as a predetermined storage format;

inputting the first component and the second component of the high dynamic range image into a predetermined deep neural network, and using the deep neural network to perform mapping on the first component and the second component respectively so as to obtain a first mapped component and a second mapped component; and

fusing the first mapped component and the second mapped component with the third component to obtain a fused low dynamic range image corresponding to the high dynamic range image.

Optionally, before said performing the image decomposition on the high dynamic range image, the method further includes:

performing an image conversion on the high dynamic range image to convert the high dynamic range image into a high dynamic range image in the predetermined storage format, and performing the image decomposition on the high dynamic range image converted into the predetermined storage format, when determining that the high dynamic range image is not in the predetermined storage format.

Optionally, the predetermined storage format includes an HSV color space, said performing the image decomposition on the high dynamic range image to obtain the first component, the second component, and the third component of the high dynamic range image includes:

extracting components in the HSV color space corresponding to the high dynamic range image to obtain the first component, the second component, and the third component; where the first component includes saturation information, the second component includes value information, and the third component includes hue information.

Optionally, the predetermined deep neural network is a generative adversarial network which includes a generative network and a discrimination network, where:

the generative network is established based on a U-Net network and includes an encoder and a decoder, the encoder includes at least one convolution block and a plurality of residual blocks, and the decoder includes a plurality of deconvolutional blocks;

the discrimination network includes a plurality of convolutional blocks, and each of the plurality of convolutional blocks includes a convolutional layer, a normalization layer and an activation layer arranged in sequence.

Optionally, the generative adversarial network is obtained by training according to a predetermined loss function, the loss function includes at least one from a group consisting of a generative adversarial loss function, a mean square error function, and a multi-scaling structure similarity loss function.

Optionally, said fusing the first mapped component and the second mapped component with the third component to obtain the fused low dynamic range image corresponding to the high dynamic range image includes:

superimposing the first mapped component and the second mapped component with the third component to obtain the low dynamic range image in the predetermined storage format.

Optionally, after obtaining the low dynamic range image in the predetermined storage format, the method further includes:

performing an image conversion on the low dynamic range image to convert the low dynamic range image into a low dynamic range image corresponding to an RGB color space.

An electronic device is provided in another embodiment of the present disclosure, the electronic device includes a memory, a processor and a computer program stored in the memory and executable by the processor, the processor is configured to, when executing the computer program, implement the aforesaid tone mapping method.

According to at least one technical solution disclosed in the embodiments of the present disclosure, some beneficial effects can be achieved and are listed below:

According to the present disclosure, one or a plurality of high dynamic range images are obtained, and the storage format of the high dynamic range image is determined, when the storage format of the high dynamic range image is a predetermined storage format, the high dynamic range image is decomposed into the first component, the second component, and the third component; the first component and the second component are input into the predetermined deep neural network which is used to perform mapping on the first component and the second component respectively to obtain the first mapped component and the second mapped component; and the first mapped component and the second mapped component are fused with the third component to obtain a fused low dynamic range image corresponding to the high dynamic range image, thereby accomplishing the tone mapping. By applying the technical solutions of the present application, noise interference can be avoided, the chromatic aberration of the low dynamic range image after tone mapping processing is reduced, and the conversion from the high dynamic range image to the low dynamic range image can be accomplished more robustly.

### BRIEF DESCRIPTION OF THE DRAWINGS

In order to describe the embodiments of the present disclosure or technical solutions in the related art more clearly, a brief introduction regarding the accompanying drawings that need to be used for describing the embodiments or the prior art is given below; it is obvious that the accompanying drawings described below are only some embodiments of the present disclosure, the person of ordinary skill in the art may also obtain other drawings according to these drawings without paying creative labor.

FIG. 1 is a schematic flowchart of atone mapping method according to one embodiment of the present application;

FIG. 2 is a schematic flowchart of using generative adversarial network to perform tone mapping in a specific application scenario according to one embodiment of the present application; and

FIG. 3 is a schematic block diagram of an electronic device according to one embodiment of the present application.

### DETAILED DESCRIPTION OF EMBODIMENTS

In order to make the ordinarily skilled one in the art to understand the technical solutions of the present application better, the technical solutions in the embodiments of the present application will be described in detail below with reference to the accompanying drawings in the embodiments of the present application. It is obvious that the embodiments described below are only some embodiments of the present application but not all of the embodiments. Based on the embodiments in the present application, other embodiments which are obtained by the person of ordinary skill in the art at without paying creative labor should all be included in the protection scope of the present application.

With the development of digital image processing technology, the high dynamic range video (HDR) technology, which is taken as one of the important branches in the technical field of image processing, is also fast developing, and various contents such as videos and images with high dynamic ranges are increasing. A high dynamic range image may be considered as an image having normal dynamic range, and can provide more dynamic ranges and image details, thus, the high dynamic range image can restore a visual effect in a real environment better. The dynamic range refers to a ratio of the highest value to the lowest value in a scenario, in practical application, an image with a dynamic range that exceeds 10⁵ can be considered as a high dynamic range image. However, since most multimedia devices still display images having limited dynamic range (i.e., low dynamic range), high dynamic range images cannot be normally displayed on these multimedia devices, so that how to properly display high dynamic range images on such devices, that is, tone mapping technology, has become a more important technique in the digital image processing technical field.

Tone mapping refers to a computer graphics technology that approximately displays a high dynamic range image on a medium having limited dynamic range medium, the medium having limited dynamic range includes a liquid crystal display (Liquid Crystal Display, LCD) device, projector equipment, and the like. Since the tone mapping is a pathological issue, and is limited to conditions such as bit depth of a multimedia device, thus, the high dynamic range images cannot be completely and consistently reproduced on the multimedia device, so that how to preserve as many local image details as possible while compressing the dynamic range of the image, that is, how to restore as high dynamic range images as much as possible has become an emphasis of research.

In the prior art, a high dynamic range image is divided into a basic layer and a detail layer by a filter, the base layer includes low-frequency information such as value of image, the detail layer includes high-frequency information such as image edge, the basic layer is compressed, and the detail layer is enhanced; finally, the base layer and the detail layer are fused into a low-dynamic range image. However, there are many defects in the existing image processing method, for example, a filtering process may introducing noises such as halo, artifact and the like, and it is difficult to eliminate these noises; moreover, the noises may seriously affect the result of tone mapping of an image, so that chromatic aberration is prone to be caused and the naturalness of the image is reduced.

Furthermore, in the related art, although an approach of using a deep learning method to complete tone mapping has been proposed, however, the existing deep learning method is used to directly perform tone mapping based on RGB color space, so that a problem of chromatic aberration still cannot be avoided; furthermore, in the existing deep learning method, the image after tone mapping process and obtained by the conventional filtering method is still used as a label for deep learning training, however, the chromatic aberration of the low dynamic range image which is obtained by the conventional filtering method is relatively greater, such that the image label for deep learning training has a poor quality, and thus it is difficult to learn a high-quality image after tone mapping.

Therefore, aiming at the high dynamic range image, there is a need to provide a tone mapping method that can avoid noise interference, reduce chromatic aberration of tone mapping images, and can complete conversion from high dynamic range image to low dynamic range images more robustly. It should be noted that the embodiments of the present disclosure are described by taking the high dynamic range image as the object to be processed, the storage format of the high dynamic range image are not limited by the embodiments of the present application; for example, the high dynamic range image in the storage format of RGB color space may be used as the object to be processed, and the high dynamic range image in the storage format of RGB color space is only one embodiment in the actual application scenario of the present disclosure, which does not constitute a limitation on the application scope of the embodiments of the present disclosure.

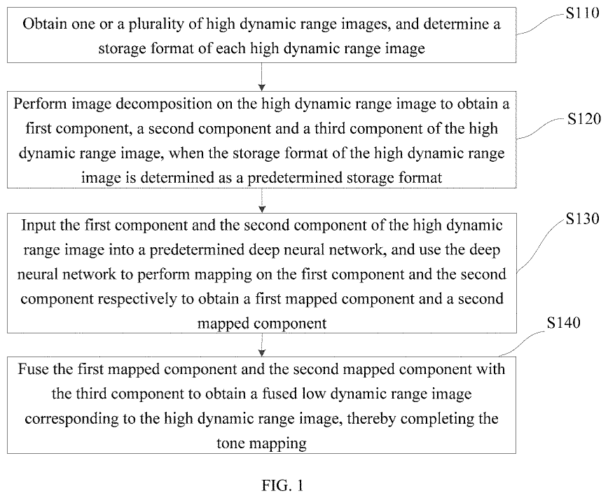

FIG. 1 is a schematic flowchart of a tone mapping method according to one embodiment of the present disclosure. The method may specifically include the following steps:

At step S110, one or a plurality of high dynamic range images are obtained, and a storage format of the high dynamic range image are determined.

In one or multiple embodiments of the present disclosure, the high dynamic range image may be considered as an object for tone mapping processing, therefore, obtaining one or a plurality of high dynamic range images may be interpreted as obtaining one or a plurality of originally processed objects or target images. According to the contents described above, the original processed object in the embodiments of the present disclosure may be a high dynamic range image stored in any storage format, in practical application, the storage format of the high dynamic range image includes but is not limited to color space (also referred to as standard Red Green Blue) such as RGB, HSV, CMY, CMYK, YIQ, Lab, etc.

Furthermore, in the embodiments of the present disclosure, due to the fact that images are stored in a computer in a four-dimensional matrix, it is considered that different matrices and color variables may be used in the storage formats of different color spaces, as a consequence, the storage format of the high dynamic range image can be determined by analyzing a matrix structure or a color of the high dynamic range image. For example, regarding hue saturation value (Hue Saturation Value, HSV) color space, the spatial matrix structure of the HSV color space is a hexagonal cone model, and the color of the image is described by hue, saturation, and value.

At step S120, when the storage format of the high dynamic range image is determined as the predetermined storage format, an image decomposition is performed on the high dynamic range image to obtain a first component, a second component and a third component of the high dynamic range image.

In one or multiple embodiments of the present disclosure, based on the determination of the storage format of the high dynamic range image in the aforesaid embodiment (i.e., determination of the color space), and a next operation is performed according to the determination result of the storage format of the high dynamic range image, which may include the conditions listed below:

Condition one, when the storage format of the high dynamic range image is determined as the predetermined storage format, an image decomposition is performed on the high dynamic range image to obtain the first component, the second component and the third component of the high dynamic range image.

Furthermore, in this embodiment of the present disclosure, the predetermined storage format may be an HSV color space, when the storage format of the high dynamic range image is determined as the HSV color space, the image decomposition processing may be directly performed on the target image (i.e., the high dynamic range image), so that the first component, the second component, and the third component of the target image are obtained.

Condition two, when the storage format of the high dynamic range image is determined as one different from the predetermined storage format, that is, the storage format of the target image is not the HSV color space, for example, the storage format of the target image is determined as the RGB color space; in this condition, an image conversion processing needs to be performed on the high dynamic range image to convert the high dynamic range image into a high dynamic range image in the predetermined storage format (i.e., the HSV color space), thereby performing the image decomposition processing on the converted high dynamic range image, before the image decomposition is performed on the high dynamic range image.

Furthermore, in this embodiment of the present disclosure, taking the target image (i.e., the originally processed object) as the high dynamic range image in the format of RGB color space as an example, the high dynamic range image may be converted from the RGB color space to the HSV color space based on the computer vision processing technology under open source computer vision library. Therefore, by converting the storage format of the high dynamic range image, a high dynamic range image conforming to the predetermined storage format may be obtained, so that the originally processed object can be converted into an image to be processed and this image to be processed is directly used for decomposition.

In one specific embodiment of the present disclosure, after the high dynamic range image in the storage format of HSV color space are obtained, the image decomposition processing may be performed on the high dynamic range image according to the following methods so as to obtain the first component, the second component and the third component of the high dynamic range image, the methods may include the following contents:

extracting components in the HSV color space corresponding to the high dynamic range image to obtain the first component, the second component and the third component; where the first component includes saturation information, the second component includes value information, and the third component includes hue information.

Since colors of an image are described using hue, saturation and value in the HSV color space, thus, hue component (hue channel), saturation component (saturation channel) and value component (value channel) are included in the HSV color space, the three components can be directly extracted from the HSV color space and denoted as the first component, the second component, and the third component, thus, the three components described above may be extracted directly from HSV color space and are recorded as the first component, the second component and third component, where, the first component may be used to represent saturation information, the second component may be used to represent image value information, the third component may be used to represent hue information, the “first” in the first component, “second” in the second component, and “third” in the third component are merely used to distinguish different components, the “first”, the “second” and “third” are not taken as limitations to the titles and the contents of the components.

It should be noted that, in the embodiments of the present disclosure, the originally processed object is converted into the HSV color space, and the components of the high dynamic range images in the HSV color space are decomposed, the significance of this is that tone mapping is mainly aiming at compressing dynamic range, however, the hue problem is generally solved by color gamut mapping, thus, the high dynamic range image in the storage format of RGB color space is converted into the high dynamic range image in the storage format of HSV color space, and is decomposed into the hue channel, the saturation channel and the value channel, where the hue channel contains hue information, the saturation channel contains saturation information, and the value channel contains value information, mapping of the saturation component and the value component are leaned, the hue component is not processed temporarily, the hue component is retained, then, the saturation component, the value component and the hue component are fused to generate the low dynamic range image, since the hue component is retained, so that the influence on the color is reduced, and the chromatic aberration of the image after tone mapping processing is reduced accordingly.

At step S130, the first component and the second component are input into a predetermined deep neural network, and the deep neural network is used to perform mapping on the first component and the second component to obtain a first mapped component and a second component.

In one or multiple embodiments of the present disclosure, the predetermined deep neural network is a generative adversarial network, and the generative adversarial network may include a generative network and a discrimination network, and the architectures of the generative network and the discrimination network are described below:

The generative network is established based on a U-Net network, and the generative network includes an encoder and a decoder, where the encoder includes at least one convolution block and a plurality of residual blocks, and the decoder comprises a plurality of deconvolutional blocks.

Furthermore, in the embodiments of the present disclosure, the generative network may also be referred to as a generator, the generative network is established based on the U-NET network architecture; the encoder includes one convolution block and four residual blocks, where the convolution block includes a convolutional layer and an activation layer, a size of a convolution kernel of the convolutional layer is 3*3, a step length is 2, a filling of the convolutional layer is 1, and the number of channels of the convolutional layer is 64; each residual block includes a convolutional layer, an activation layer, another convolutional layer, and another activation layer which are arranged in sequence, the input information of the current residual block and the output information of the second convolutional layer are added before the second activation layer; where the size of the convolution kernel of the convolutional layer in the residual block is 3*3, the step length of the convolutional layer in the residual block is 2, the number of channels of each residual block is incremented by twice from 64, the activation layer in the encoder uses a rectified linear unit (Rectified Linear Unit, RELU) activation function, in order to keep the size of the feature map unchanged, edge filling is performed in a mirror symmetry manner; a channel is further connected after the last residual block of the encoder is 512, and feature transformation is performed on a convolutional layer having a convolution kernel of 1*1 and a channel of 512.

The decoder includes five deconvolutional blocks arranged in sequence, and sampling is performed, the convolution kernel of the deconvolutional layer (i.e., transposed convolutional layer) in each deconvolutional block is 3*3, the step length is 2, and the number of channels is decremented by one-half. A skipping connection is added between the convolutional blocks of the coders and the encoders with the same resolution so as to restore the loss of spatial structure information caused due to halving of the resolutions of the convolutional blocks. Two convolutional blocks after the decoder are connected for fine tuning, the convolution kernel of the convolutional layer in each of the two convolutional blocks is 3*3, the step size is 1, and the channels of the two convolutional blocks are 64 and 2 respectively, except that the last activation layer adopts Sigmoid function, the other activation layers adopts RELU activation function.

The discrimination network includes a plurality of convolutional blocks, and each of the convolution blocks includes a convolutional layer, a normalization layer and an activation layer which are arranged in sequence. Furthermore, in the embodiments of the present disclosure, the discrimination network may also be referred to as a discriminator, the discrimination network is composed of four convolutional blocks, the size of convolution kernel of the convolutional layer in each of the convolution blocks is 3*3, the step length is 2, the normalization layer in the discrimination network adopts layer normalization, and the activation layer adopts the RELU activation function.

In practical application, the generative adversarial network may be trained by a predetermined loss function, and the loss function includes one or more from a group consisting of a generative adversarial loss function, a mean square error function, and a multi-scaling structure similarity loss function.

At step S140, the first mapped component and the second mapped component are fused with the third component to obtain a fused low dynamic range image corresponding to the high dynamic range image, thereby completing tone mapping.

In one or multiple embodiments of the present disclosure, the contents of the aforesaid embodiments are continued, after the value component and the saturation component are input into the generative adversarial network to learn mapping, the mapped value component and the mapped saturation component are output, and the mapped value component and the saturation component are fused with the hue component to obtain the fused low dynamic range image corresponding to the originally processed object (i.e., the high dynamic range image), thereby completing the tone mapping.

Furthermore, in the embodiments of the present disclosure, the aforesaid components may be fused to obtain the low dynamic range image using the following method, which specifically includes:

superimposing the first mapped component and the second mapped component with the third component to obtain the low dynamic range image in the predetermined storage format.

In a specific implementation scenario of the present disclosure, since the first component, the second component, and the third component correspond to the saturation channel, the value channel, and the hue channel in the HSV color space respectively, the saturation channel and the value channel obtained after learning mapping are fused with the original hue channel to obtain the low dynamic range image corresponding to the HSV color space. Therefore, in order to facilitate restoring the low dynamic range image to the color space (e.g., the RGB color space) corresponding to the originally processed object, after obtaining the low dynamic range image in the predetermined storage format, the method may further includes: performing an image conversion on the low dynamic range image to convert the low dynamic range image into a low dynamic range image corresponding to the RGB color space; of course, it can be easily understood that the color space corresponding to the originally processed object (i.e., the high dynamic range image) is not specifically limited in the embodiments of the present disclosure, thus, Which color space the low dynamic range image is converted into may be determined according to actual requirement.

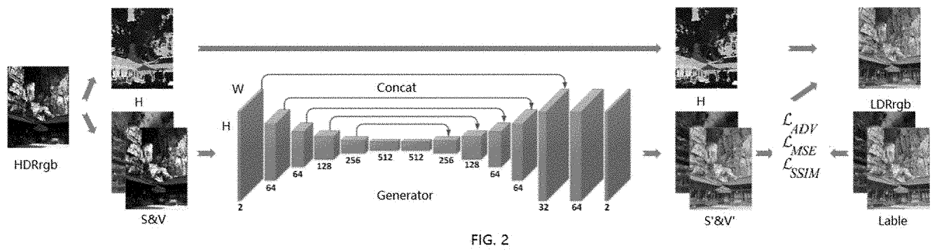

The process of tone mapping using the generative adversarial network is described below with reference to one embodiment. As shown in FIG. 2, FIG. 2 is a schematic flowchart illustrating tone mapping using the generative adversarial network in a specific application scenario according to this embodiment of the present disclosure. According to the contents of the aforesaid embodiment and with reference to FIG. 2, based on the architecture of the generative adversarial network disclosed in this embodiment of the present disclosure, sufficient multi-scaling information is learned by using the U-Net network architecture in the generator. Since tone mapping is mainly the mapping of value of image, information including the structure of the object is invariable, so that residual blocks are introduced into the encoder, the difficulty of network learning is reduced while the structural integrity is maintained and information loss is avoided. In addition, since an unrealistic mapping result is usually obtained through tone mapping, the generative adversarial network is utilized to introduce adversarial loss to improve the naturalness of mapped picture by learning on a perception level.

In this embodiments of the present disclosure, the saturation component and the value component of the high dynamic range image are simultaneously input into the generative adversarial network for learning mapping, and the original hue component is reserved, and finally, the original hue component is fused with the saturation component and the value component to generate the low dynamic range image. In the training process of the generative adversarial network, due to the introduction of the generative adversarial loss and the structural similarity loss, the image, which is obtained by fusing the value component with the saturation component obtained by the generative adversarial network after learning mapping according to the present disclosure, is not only is highly consistent with the original high dynamic range image, but also has very high naturalness, so that the problem of chromatic aberration is avoided while mapping of value and saturation is leaned.

The image obtained by using the tone mapping in the embodiments of the present disclosure is used as a data set for training the generative adversarial network, so that the effect of learning of neural network can be improved, and a tone mapping label data set with high-quality can also be obtained by adjusting parameters.

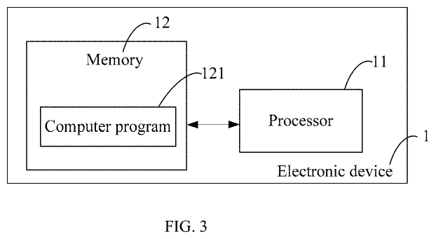

As shown in FIG. 3, an electronic device 1 is further provided in one embodiment of the present disclosure, the electronic device 1 includes a memory 12, a processor 11 and a computer program 121 stored in the memory 12 and executable by the processor 11, the processor 11 is configured to, when executing the computer program 121, implement the aforesaid tone mapping method.

The electronic device provided in the embodiments of the present disclosure corresponds to the method embodiment, therefore, the electronic device 1 also has the beneficial technical effects similar to that of the corresponding tone mapping method. Since the beneficial technical effects of the tone mapping method have been described in detail above, the beneficial technical effects of the electronic device 1 corresponding to the tone mapping method are not repeatedly described herein.

The descriptions of the disclosed embodiments enables those skilled in the art to make or use the present disclosure. It is obvious to those skilled in the art that, various modifications can be made in these embodiments, a generic principle defined herein may be implemented in other embodiments without departing from the spirit and the scope of the present disclosure. Thus, the present disclosure will not be limited to these embodiments shown herein; instead, the present disclosure should be in accordance with the broadest scope consistent with the principles and novel features disclosed in the present disclosure.

What is claimed is:

1. A tone mapping method implemented by an electronic device, the method comprising:
obtaining one or a plurality of high dynamic range images, and determining a storage format of each high dynamic range image;
performing an image decomposition on the high dynamic range image to obtain a first component, a second component and a third component of the high dynamic range image, when the storage format of the high dynamic range image is determined as a predetermined storage format;
inputting the first component and the second component of the high dynamic range image into a predetermined deep neural network, and using the deep neural network to perform mapping on the first component and the second component respectively so as to obtain a first mapped component and a second mapped component; and
fusing the first mapped component and the second mapped component with the third component to obtain a fused low dynamic range image corresponding to the high dynamic range image.

2. The method according to claim 1, wherein before said performing the image decomposition on the high dynamic range image, the method further comprises:
performing an image conversion on the high dynamic range image to convert the high dynamic range image into a high dynamic range image in the predetermined storage format, and performing the image decomposition on the high dynamic range image converted into the predetermined storage format, when determining that the high dynamic range image is not in the predetermined storage format.

3. The method according to claim 1, wherein the predetermined storage format comprises an HSV color space, said performing the image decomposition on the high dynamic range image to obtain the first component, the second component, and the third component of the high dynamic range image comprises:
extracting components in the HSV color space corresponding to the high dynamic range image to obtain the first component, the second component, and the third component; wherein the first component comprises saturation information, the second component comprises value information, and the third component comprises hue information.

4. The method according to claim 1, wherein the predetermined deep neural network is a generative adversarial network which comprises a generative network and a discrimination network, wherein:
the generative network is established based on a U-Net network and comprises an encoder and a decoder, the encoder comprises at least one convolution block and a plurality of residual blocks, and the decoder comprises a plurality of deconvolutional blocks;
the discrimination network comprises a plurality of convolutional blocks, and each of the plurality of convolutional blocks comprises a convolutional layer, a normalization layer and an activation layer arranged in sequence.

5. The method according to claim 4, wherein the generative adversarial network is obtained by training according to a predetermined loss function, the loss function comprises at least one from a group consisting of a generative adversarial loss function, a mean square error function, and a multi-scaling structure similarity loss function.

6. The method according to claim 1, wherein said fusing the first mapped component and the second mapped component with the third component to obtain the fused low dynamic range image corresponding to the high dynamic range image comprises:
superimposing the first mapped component and the second mapped component with the third component to obtain the low dynamic range image in the predetermined storage format.

7. The method according to claim 6, wherein after obtaining the low dynamic range image in the predetermined storage format, the method further comprises:
performing an image conversion on the low dynamic range image to convert the low dynamic range image into a low dynamic range image corresponding to an RGB color space.

8. An electronic device, comprising a memory, a processor and a computer program stored in the memory and executable by the processor, wherein the processor is configured to, when executing the computer program, implement method steps, comprising:
obtaining one or a plurality of high dynamic range images, and determining a storage format of each high dynamic range image;
performing an image decomposition on the high dynamic range image to obtain a first component, a second component and a third component of the high dynamic range image, when the storage format of the high dynamic range image is determined as a predetermined storage format;
inputting the first component and the second component of the high dynamic range image into a predetermined deep neural network, and using the deep neural network to perform mapping on the first component and the second component respectively so as to obtain a first mapped component and a second mapped component; and
fusing the first mapped component and the second mapped component with the third component to obtain a fused low dynamic range image corresponding to the high dynamic range image.
